(19) United States
(12) Patent Application Publication
(10) Pub. No.: US 2007/0190871 A1
(43) Pub. Date: Aug. 16, 2007

(54) Sealing material

(76) Inventors: Malay Patel, Cochranville, PA (US); Michael James Napolitano, Newark, DE (US); James R. Hanrahan, Newark, DE (US)

Correspondence Address: Carol A. Lewis White, Esquire;W. L. Gore & Associates, Inc., 551 Paper Mill Road, Newark, DE, 19714-9206, US

(21) Appl. No.: 11/250,121

(22) Filed: Oct. 12, 2005

Related U.S. Application Data
(63) Continuation-in-part of application No. 10/841,041, filed on May 7, 2004, now abandoned.

(51) Int. Cl. B32B 27/04; B32B 27/12; B32B 27/32; B32B 5/12; B32B 5/02

(52) U.S. Cl. 442/43; 442/38; 442/40; 442/58

(57) ABSTRACT

A sealing material is presented which can be applied to surfaces and/or surfaces having seams, cracks, crevices and the like to hinder growth and colonization of bacteria while maintaining adhesion over a wide range of service, or use, conditions. The sealing material includes a fluoropolymer layer and a rubber based adhesive layer which is capable of adhering the sealing material to the surface or surfaces to be sealed. The invention combines the inherent anti-stick and hydrophobic properties of fluoropolymers with excellent adhesive characteristics of the rubber based adhesive.

### CROSS-REFERENCE TO RELATED PATENT APPLICATIONS

The present application is a continuation-in-part application of U.S. patent application Ser. No. 10/841,041, entitled “Sealing Material,” filed May 7, 2004 in the names of Malay Patel et al.

### FIELD OF THE INVENTION

The present invention relates to a thermally stable, chemically inert, easily cleaned, hydrophobic material that is an effective barrier to microbial contaminants.

### BACKGROUND OF THE INVENTION

Bacterial contamination of food represents one of the major public health problems worldwide. Food contamination is endemic in underdeveloped countries, and is a major cause of disease and death. It is also a major source of illness in developed countries including the United States. The actual incidence of bacterial food-borne illness is unknown, but the CDC estimates it to be between 7 to 81 million illnesses per year, with over 325,000 hospitalizations, and 5,000 deaths in the U.S. annually. The costs of human illness in the U.S. due to food-borne pathogens are in the billions annually. In addition to the toll of illness and death, contaminated food represents a huge economic loss for many food-processing plants.

Current stringent sanitation procedures in food processing plants are effective in reducing the incidence of bacterial contamination of food, but have not prevented the occurrence of serious outbreaks resulting in death and disability. The current consensus is that the total elimination of pathogenic bacteria from food is unrealistic. For example, the World Health Organization has stated that the total elimination of Listeria monocytogenes (L. monocytogenes) from food is “impractical and may be impossible.” Problems caused by microbial contamination of foods tend to be expensive; particularly if these result in consumer recalls.

Poor sanitation of food contact surfaces, equipment, and processing environments has been a contributing factor in food-borne disease outbreaks, especially those involving L. monocytogenes and Salmonella. Improperly cleaned surfaces promote soil buildup, and, in the presence of water, contribute to the development of bacterial biofilms, which may contain pathogenic microorganisms (Boulange-Peterman and others 1993). Cross contamination occurs when food passes over contaminated surfaces or via exposure to aerosols or condensate that originate from contaminated surfaces (Barnes and others 1999, Boulange-Peterman 1996, Bower and others 1996). Frank and Chmielewski (1997) and Holah and others (1990) demonstrated that the type of food contact surface and topography play a significant role in the inability to decontaminate a surface. Abraded surfaces accumulate soil and are more difficult to clean than smooth surfaces. Surface defects further complicate the removal of soil and bacteria (Boulange-Peterman 1996, and others 1997; Bower and others 1996; Mafu and others 1990), with the result that surviving bacteria can re-grow and produce a biofilm. Bacteria within a biofilm are more resistant to disinfectants, which may assist the survival of Listeria and other food-borne pathogens in the food processing environment (Bower and others 1996). Hence, proper control methods for biofilms are necessary for a safe food processing operation.

L. monocytogenes is a pathogen that occurs widely in both agricultural (e.g., soil, water, and plants) and food processing environments (e.g., air, drains, floors, machinery) (Ryser 1999). L. monocytogenes grows at low oxygen conditions and refrigeration temperatures, and therefore survives for long periods of time in the environment, on foods, in processing plants, and in household refrigerators. Although frequently present in raw foods (dairy, meat, poultry, fruits, and vegetables), it can also be present in ready-to-eat (RTE) foods due to post-processing contamination (Mead 1999a, CDC 2000) Efforts to control L. monocytogenes have reduced the amount and level of contamination, but it has not been possible to eradicate it from the processing environment nor to eliminate the potential for contamination of finished products. However, because of the serious illness, and even death, that can result in susceptible individuals, it is imperative that industry take stringent measures to control the potential for contaminating RTE foods. Since U.S. regulatory agencies consider L. monocytogenes in RTE foods an adulterant, they request that companies recall product found to contain L. monocytogenes.

One way to reduce contamination is to “build in” hygiene into the equipment used in the food manufacturing facility. The hygienic design of equipment can play an important role in controlling the microbiological safety and quality of the products made.

Cracks and crevices on food processing equipment and infrastructure within the food processing plant are difficult to clean and often can provide safe harbor for foodborne pathogens. High humidity and difficult accessibility combine to make these areas ideal locations for the growth of bacterial biofilms, which are subsequently the source for future cross contamination of foods.

One method to minimize the effect of the cracks and crevices in the equipment is to seal them. Spray applied coatings such as polyurea barrier coatings can be used but have some disadvantages. Complex geometries within the plant make spray applications difficult. Chemicals from foodstuffs, marinades, or sanitizing solutions may degrade the coating materials, and some coatings exhibit poor or reduced adhesion over the broad thermal cycling range of the equipment, such as freezers, ovens and other automated forms of food processing equipment.

Antimicrobial materials may passivate or be rendered ineffective when coated by foodstuffs such as protein fat. Additionally the active antimicrobial ingredients may eventually leach out of the polymer over time and become ineffective.

There exists a need for a thermally stable, chemically inert, easily cleaned, hydrophobic material that is an effective barrier to microbial contaminants.

Accordingly, it is a primary purpose of the present invention to provide a multilayer sealing material that can cover surfaces, seams, cracks and crevices to block or inhibit the growth and colonization of bacteria.

These and other purposes of the present invention will become evident from a review of the following specification.

### SUMMARY OF THE INVENTION

The present invention is a sealing material comprising a multi-layer construction which can be applied to a surface or over seams, cracks and other crevices to block or hinder growth and colonization of bacteria while maintaining adhesion over a wide range of service conditions. The invention combines the inherent anti-stick and hydrophobic properties of fluoropolymers with excellent adhesive characteristics.

The sealing material, which may be in tape, sheet, or other suitable form, comprises in one embodiment a fluoropolymer layer bonded to a rubber based adhesive layer. The fluoropolymer layer provides, among other things, good resistance to microbial contamination during use. The rubber based adhesive layer, among other things, is capable of adhering the sealing material to a surface of interest and maintain that seal over a range of temperature. In one embodiment, the sealing material is capable of maintaining a seal over a temperature range extending at least from about −60° C. to about 40° C. Other temperature range conditions are also contemplated, depending on the operational conditions of the particular surface in use.

Any fluoropolymer having a surface energy of 25 dynes/cm or less and which is hydrophobic, i.e., having a contact angle of 1000 or greater, can be used as the fluoropolymer layer. Fluoropolymers are preferred over other surfaces due to their known hydrophobic character, anti-stick properties and cleanability. Dense PTFE is one example of a suitable fluoropolymer layer, and a densified expanded PTFE (i.e., having a density of 2.2 g/cc or greater) another example of a suitable fluoropolymer layer, due to, among other things, its excellent cleanability, toughness and barrier properties.

Rubber based adhesives suitable for the present invention are any rubber based materials capable of bonding the fluoropolymer layer to a surface and maintaining that bond over the operational conditions (e.g., temperature range, chemical conditions, etc.) to which the sealing material is exposed. As used herein, the term “rubber based” means materials having generally elastic properties, and these materials may be either natural or synthetic in composition. Examples of suitable rubber based adhesives include those adhesives made from materials including, but not limited to, natural rubbers, butyl rubbers, isoprene, styrene butadiene rubber, chloroprene, polyisobutylene, styrenic block copolymers, and such other comparable materials which exhibit elastic properties.

The fluoropolymer layer can be bonded to the rubber based adhesive layer by any suitable bonding means, including the rubber based adhesive itself, any other appropriate adhesive, sodium treatment, plasma treatment, corona treatment, flame treatment, or the like.

In an alternative embodiment, the sealing material may further include one or more reinforcing materials, such as a films, fibers, mesh, weaves, nonwovens, knits, and comparable supporting structures. Examples of suitable compositions for the reinforcement materials can include, but are not limited to metals, ceramics, polymeric materials, natural materials, etc., depending on the desired use conditions and performance for the sealing material. In one embodiment, the reinforcing material can be embedded at least partially within the rubber based adhesive. In another embodiment, the reinforcing material may be a separate layer between the fluoropolymer layer and the rubber based adhesive layer, and it may be a single material or a composite. The fluoropolymer layer can be bonded to the reinforcing material layer by any suitable bonding means. Suitable bonding means can include, but are not limited to, for example, melt processable fluoropolymers such as ETFE (ethylene tetrafluoroethylene), EFEP (ethylene fluoroethylenepropylene), PFA (perfluoroacrylate), FEP (fluoroethylenepropylene), THV (a polymer of tetrafluoroethylene, hexafluoropropylene and vinylidene fluoride), PVDC (polyvinylidene chloride) and PVF2 (polyvinylidene fluoride).

In one embodiment of the invention, sealing materials of the present invention can exhibit a hardness, or durometer, value on the order of about 60 (Shore D).

The resulting sealing material comprises a thermally stable, chemically inert, easily cleaned, hydrophobic material that is an effective barrier to microbial contaminants and which can be incorporated to cover surfaces, seams, cracks and crevices to block or hinder the growth and colonization of bacteria.

### DESCRIPTION OF THE DRAWINGS

The foregoing summary, as well as the following detailed description of the invention, will be better understood when read in conjunction with the appended drawings. For purposes of illustrating the invention, there are shown in the drawings embodiments which are presently preferred. It should be understood, however, that the invention is not limited to the precise arrangements and instrumentalities shown. In the drawings:

FIGS. 1A, 1B, 1C and 1D are cross-sectional views of alternative embodiments of the sealing material of the present invention.

FIG. 2 is a perspective view of a sealing material of the present invention adhered over a portion of a seam between two surfaces.

FIG. 3 is a graph showing flexural modulus versus temperature of a sample made in accordance with Example 2 and of a comparative prior art material.

### DETAILED DESCRIPTION OF THE INVENTION

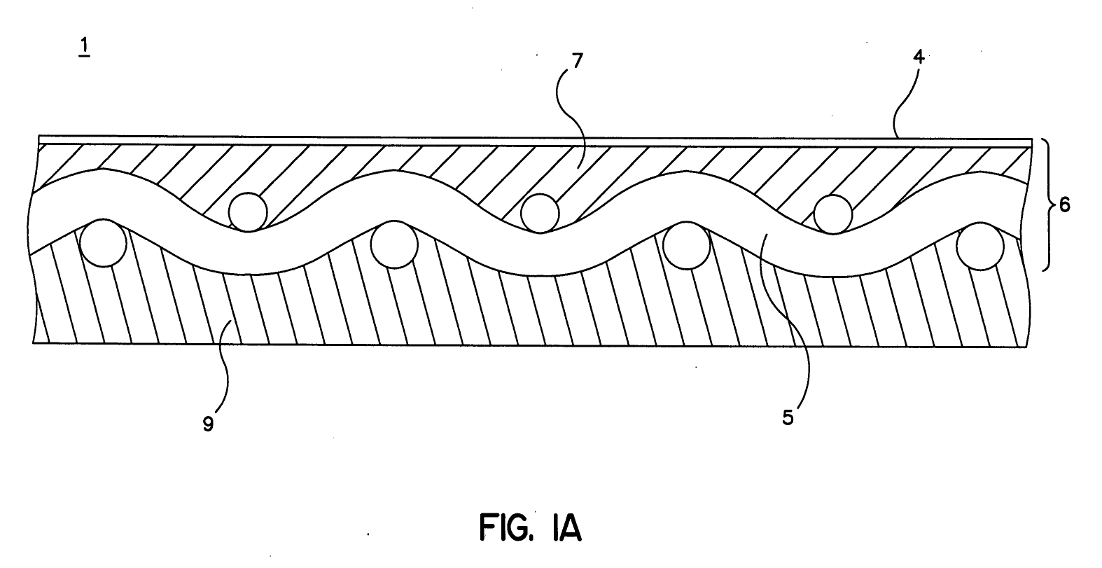

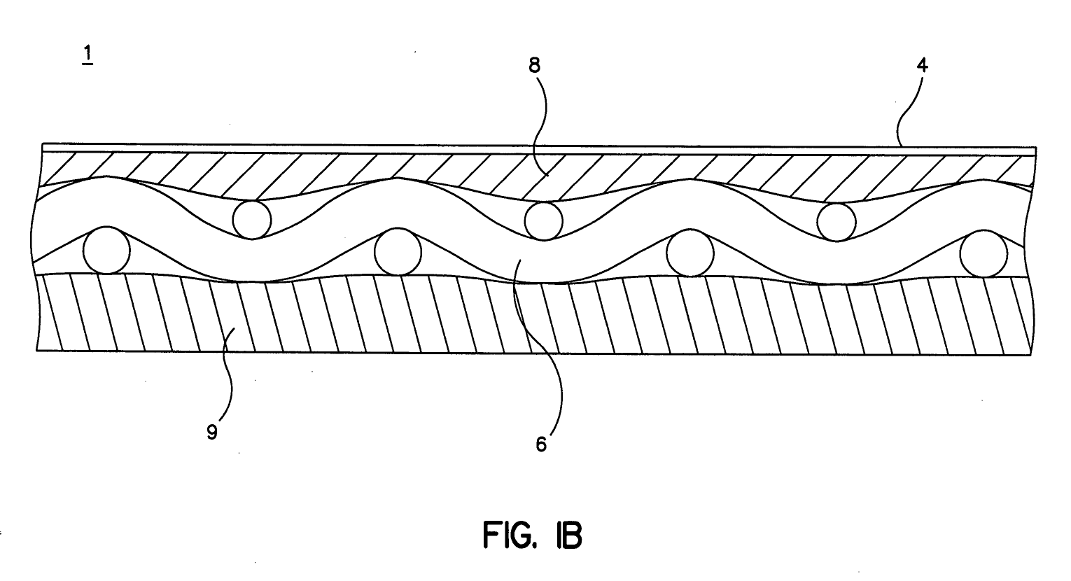

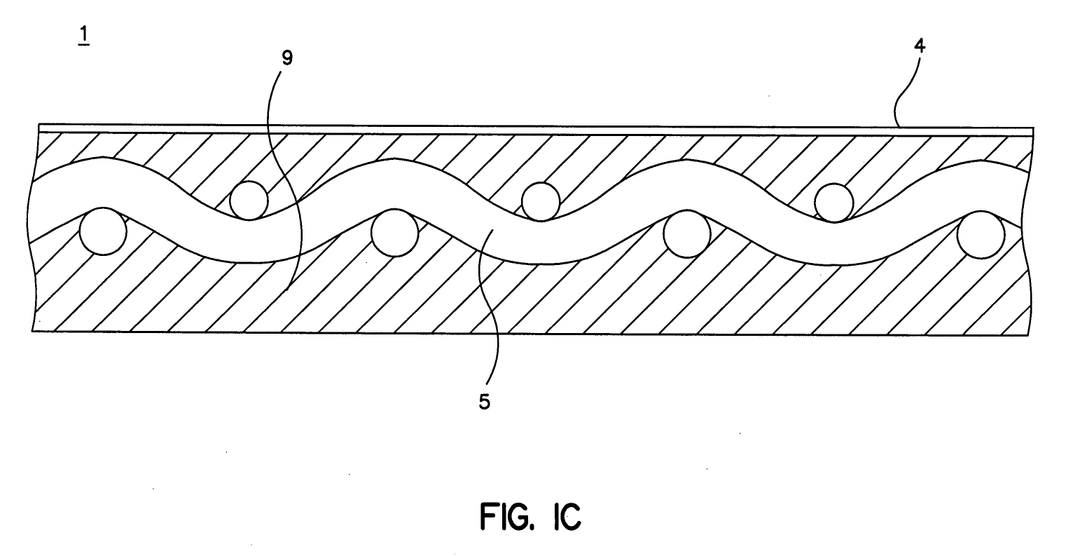

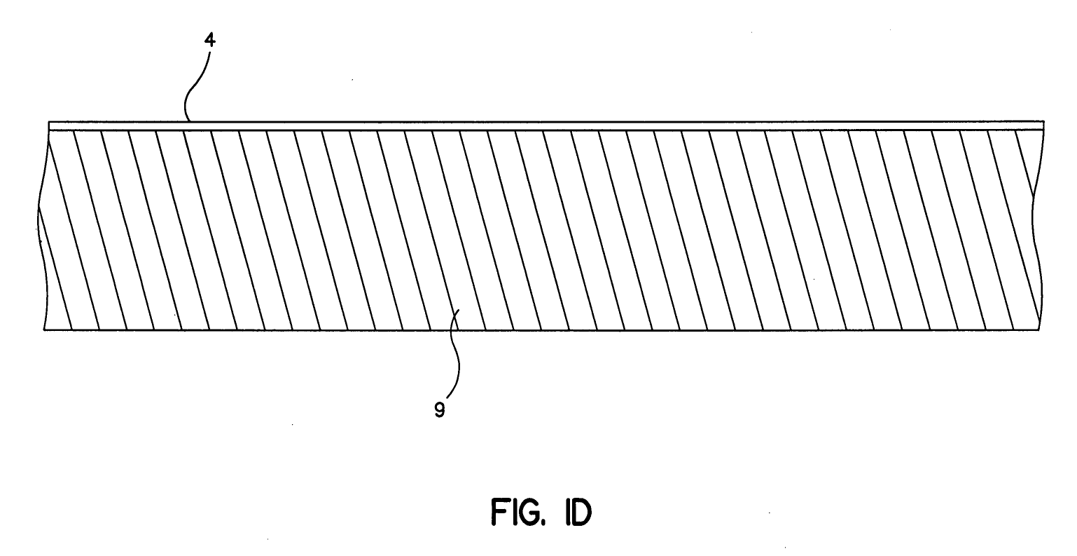

FIGS. 1A-1D illustrate alternative embodiments of a composite sealing material of the present invention. Specifically, referring to FIG. 1A, there is shown a sealing material 1 comprising a fluoropolymer layer 4, bonded to a reinforcing layer 6 comprising a woven or mesh construction 5 and a second material 7, such as a thermoplastic polymer, which at least partially encapsulates the mesh 5. Rubber based adhesive layer 9 is bonded to the reinforcing layer 6 on the side opposite the fluoropolymer layer 4. FIG. 1B shows an alternative sealing material 1 comprising fluoropolymer layer 4 bonded to reinforcing layer 6 in this embodiment comprising a woven or mesh material with an adhesive 8. Again, rubber based adhesive layer 9 is bonded to the reinforcing layer 6 on the side opposite the fluoropolymer layer 4. FIG. 1C shows a further alternative sealing material 1 wherein rubber based adhesive material 9 not only encapsulates the mesh 5 to provide a composite reinforcing layer, but also forms a bond with the fluoropolymer layer 4 and extends on the opposite side of the mesh 5 to provide a rubber based adhesive for adhering the sealing material 1 to a desired surface. FIG. 1D shows the composite sealing material without a reinforcing material. Here, the fluoropolymer layer 4 is bonded directly to the rubber based adhesive layer 9.

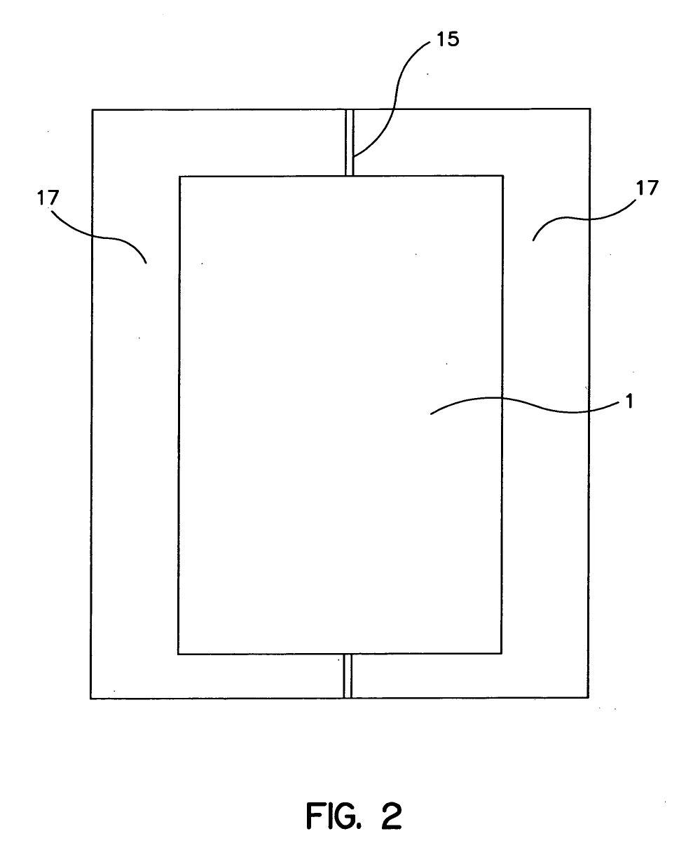

FIG. 2 is a top view of a piece of sealing material 1 adhered over a seam 15 between two abutting surfaces 17, in this particular case two metal panels.

Suitable fluoropolymer layers include any number of fluoropolymers which include, but not limited to, skived PTFE, densified PTFE, whether expanded or not, and densified PTFE with thermoplastic fluoropolymer layers. Example of suitable fluoropolymer layers include any of a number of dense (e.g., bulk density of 2.11 g/cc or greater) PTFE materials available from W. L. Gore & Associates, Inc. Other suitable thermoplastic or melt processable fluoropolymers are available in dispersion, powder, pellet or film forms from several suppliers.

In embodiments where an optional reinforcing material is included, a bonding layer can be utilized to adhere the fluoropolymer layer to the reinforcing material. While a variety of suitable bonding configurations are contemplated, several exemplary modes of the current invention are described herein and can be practiced depending on the fluoropolymer layer construction. When utilizing melt processable fluoropolymer layers, the fluoropolymer layer can function both as a barrier during use and as an adhesive which can be thermally bonded directly to the reinforcing layer. With a PTFE fluoropolymer layer, an additional adhesive layer is needed to securely bond the PTFE layer to the reinforcing material. Suitable adhesive layers include lower melt temperature melt processable fluoropolymer such as THV, EFEP, ETFE, and PVF2 to facilitate lower processing temperatures. Higher melt temperature fluoropolymers such as PFA and FEP, etc., can also be used provided higher bonding temperatures are used.

The rubber based adhesives suitable for the present invention are any rubber based materials capable of bonding the fluoropolymer layer to a surface and maintaining that bond over the operational conditions (e.g., temperature range, chemical conditions, etc.) to which the sealing material is exposed. Examples of suitable rubber based adhesives include those adhesives made from materials including, but not limited to, natural rubbers, butyl rubbers, isoprene, styrene butadiene rubber, chloroprene, polyisobutylene, styrenic block copolymers, and such other comparable materials which exhibit elastic properties.

The rubber based adhesive layer secures the multi-layer sealing material to the surface of interest. One possible surface of interest for blocking or inhibiting growth and colonization of bacteria is on cracks and crevices on food processing equipment (e.g., refrigerators, cold storage equipment, etc.) and on food processing plant infrastructures (e.g., walls and divider panels, etc.). In this and similar applications, the sealing material is envisioned to cover exposed crevices. In other applications, the sealing material is envisioned for use on “at-risk” surfaces that could retain, harbor, or promote the growth of bacterial biofilms. The sealing material provides good low temperature (e.g., about −60° C. or below) and high temperature (e.g., about 40° C. or above) adhesion to cover a broad range of equipment operating temperatures and higher temperature cleaning cycles.

### MEASUREMENT AND TEST METHODS

Contact Angle and Surface Energy Measurements

Samples of fluoropolymer films were bonded to glass slides using a pressure sensitive adhesive transfer film. The contact angles were determined for water and diiodomethane using the pendant drop method. A FTA200 Dynamic Contact Angle Analyzer from First Ten Angstroms was used to measure the contact angle. The contact angle was an average of three individual measurements. The Fowkes theory (F.M. Fowkes, Industrial and Engineering Chemistry, 56, 12, 40 (1964)) was used to calculate the surface energy of the fluoropolymer films. The diiodomethane contact angle was used to calculate the dispersive component of the surface energy due to its lack of a polar component in its surface tension. In Table 1, the water and diiodomethane contact angles are presented along with calculated surface energy.

| | Contact Angle (°) | Contact Angle (°) | Surface Energy |
|---|---|---|---|
| | Diiodomethane | Water | mJ/m² |
| PTFE | 69.2 | 116.8 | 23.3 |
| FEP (Dupont | 69.8 | 112 | 23 |
| Teflon FEP) | | | |
| PFA | 70.3 | 109.1 | 22.7 |
| THV (Dyneon | 57.4 | 96 | 30.1 |
| THV 220 g) | | | |

Diiodomethane - Aldrich Chemical 99% purity. Surface tension of 50.8 mN/m for diiodomethane was used in calculating surface energy

Hardness

The Shore D hardness was measured using a PTC Instruments Type D Durometer, model #307L, from Pacific Transducer Corp., Los Angeles, Calif.. Test samples were mounted on a stainless steel plate. The durometer tester was placed on the sample and a light hand force was applied to the tester until the base of the tester contacted the surface of the test sample. The durometer reading (Shore D scale) was read from the dial gauge on the tester and recorded.

Flexural Modulus

The flexural modulus as a function of temperature was measured on a RSA III from TA Instruments, 109 Lukens Drive, New Castle, Del. The samples were tested using the dual cantilever test geometry at a frequency of 1 Hz and a strain of 0.5% over a temperature range of −100° C. to 40° C. A 13 mm wide by 24 mm long strip was cut and mounted on the small size test frame from TA instruments and tested from cold to hot.

Test for Colonization of Bacteria

Bacteria colonization testing is carried out using a mixed culture biofilm formed by a Listeria cocktail and Pseudomonas putida. The Listeria cocktail consists of a Listeria monocytogenes, G3990, Scott A, YM96, 12374, and G3982. To prepare the inoculum, a bead from each culture is placed in separate tubes containing 10 ml of tryptic soy broth (TSB) and incubated for 24 hours at 32 EC. From this tube, 100 ml is transferred to fresh TSB and incubated as before. After two transfers, 2 ml of culture is then used to innoculate 200 ml of 10% TSB. This is then incubated at 32 EC for 24 hours and then used to prepare the biofilms.

Biofilms are produced on test surfaces cut into 7.5 by 11 cm coupons. These surfaces include a stainless steel control (type 304, #4B finish coated stainless steel). The coupons are first cleaned by immersion in 100 ml/L solution of Micro-90 Soap at 80 EC for one hour with sonication. Coupons are then rinsed in deionized water followed by sonication in 1.5% phosphoric acid solution at 80 EC for 20 minutes, and rinsing in deionized water. Clean coupons are then sanitized by submerging in deionized water and steaming for 30 minutes, followed by soaking in ethanol for 5 minutes and allowing to air dry.

Sterile coupons are placed in a flat sterile stainless steel pan and immersed in the 1 L combined inoculum of the five strains of L. monocytogenes and 200 ml of P. putida. The stainless steel is incubated with the L. monocytogenes cocktail and P. putida for 4 hours at 25 EC to allow attachment. The coupons are then rinsed with sterile phosphate buffer to remove unattached cells. They are then immersed in 1 L of 10% TSB and incubated at 25 EC for 48 hours to allow biofilm growth. After incubation the coupons are rinsed with sterile phosphate buffer and placed into another sterile pan, immersed in sterile non-fat dry milk and allowed to incubate at 32 EC for 2 hours. Following this final incubation, the coupons are again rinsed in sterile buffer and are ready for sanitizer treatment. To sanitize, biofilm containing coupons are immersed in 200 ppm Quaterary ammonium sanitizer for 5 minutes at room temperature. After this holding time, coupons are neutralized by submersion in a Lecithin/Tween 80® solution followed by rinsing with sterile phosphate buffer. Once sanitized, coupons are allowed to dry at room temperature.

Enumeration of surviving Listeria is determined, once the coupons are dry, by agar overlaying the coupons with Plate Count Agar with 0.1% potassium tellurite and incubating at 35 EC for 24-48 hours. With this medium, Listeria colonies appear black and Pseudomonas growth is inhibited. CFU/50 cm is determined. Initial biofilm zero counts are obtained by scraping cells from a positive control using a TEFLON® scraper and rinsing with 100 ml sterile phosphate buffer. This rinse solution is collected, serial diluted and placed on a petri dish containing Plate Agar Count with 0.1% Potassium Tellurite.

Without intending to limit the scope of the present invention, the following examples illustrate how the present invention may be made and used:

### EXAMPLES

### Example 1

A 4 inch by 4 inch sample of 60×60 wire mesh with 6.5 mil diameter 304 stainless steel wire (MSC Industrial Supply Co.) was laminated on a Carver Press to a composite film of densified expanded PTFE and THV 500 (PTFE layer 10 um thick, density of about 2.3 g/cc/THV layer 10 um thick, W. L. Gore and Associates, Inc. Elkton, Md.) using a 2 mil thick film of THV Grade 220 (Dyneon, Inc.) to laminate the mesh and composite film together. The layers were pressed at 180° C. for 15 minutes under 2.5 tons of force.

A layer of Dymax 621 UV curable adhesive (available from Dymax, Inc) was applied to a one inch width area of two stainless steel panels. The sealing material was then pressed into the UV adhesive and placed through a UV cure unit (Model No. LC-6B, Fusion UV Systems, Inc).

### Example 2

A sample of 200×200 wire mesh with 1.6 mil diameter 316 stainless steel wire (Newark Wire Cloth Company, Newark, N.J.) was laminated on a roll mill to a composite film of densified expanded PTFE and THV 500 (PTFE layer 10 um thick, density of about 2.3 g/cc/THV layer 10 um thick, W. L. Gore and Associates, Inc. Elkton, Md.) using a 2 mil thick film of THV Grade 220 (Dyneon, Inc.) to laminate the mesh and composite film together. The layers were laminated at 195° C. under 40 psig at a rate of 3.3 feet per minute.

A layer of butyl adhesive ( 1/16″ thick, BT 132×6W, Moreau Marketing and Sales, Winston-Salem, N.C.) was later applied on the roll mill at 60° C. and 30 psig pressure at a rate of 3.3 feet per minute.

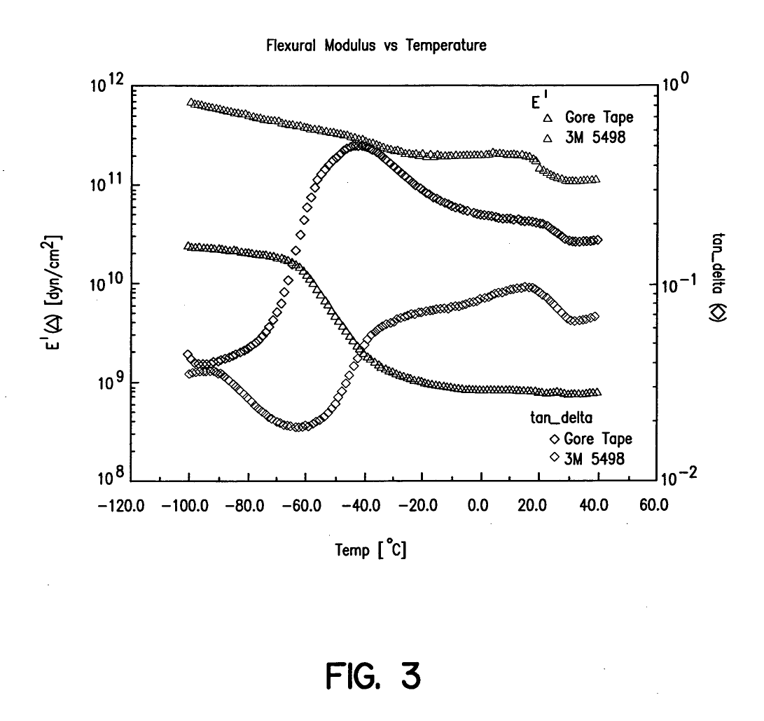

The sample made in this example was then tested for hardness in accordance with the Hardness Test described earlier herein. A hardness of 60 (Shore D) was measured. Additionally, the sample was tested for flexural modulus over a temperature range, and the results are reported in FIG. 3.

A comparative commercially available tape material, available from the 3M Company (Minneapolis, Minn.) as Part No. 5498, was also measured for flexural modulus, and the results for the 3M material are also reported in FIG. 3.

### Example 2

A layer of butyl adhesive ( 1/16″ thick, Q 207-WX-60, Moreau Marketing and Sales, Winston-Salem, N.C.) was laminated to a treated (plasma) film of densified expanded PTFE (PTFE 3 mils thick, density of 2.3 g/cc, W.L. Gore and Associates, Inc Elkton, Md.) using a roll mill at room temperature with a fixed gap of 50 mils at 5 ft/min.

### Example 3

A sample of polypropylene mesh (Delnet TK16-35P, 6.5 mil thick polypropylene square net mesh, DelStar Technologies, Inc Middletown, Del.), was laminated on a roll mill between a treated FEP film (2 mil FEP, Dupont, Wilmington, Del.) and a layer of butyl adhesive ( 1/32″ thick, BT 132×6W, Moreau Marketing and Sales, Winston-Salem, N.C.) at 60° C. under 80 psig at a rate of 3.3 feet per minute.

### Example 4

A 4 inch by 4 inch butyl rubber compound (Rubber Formulary, P A Ciullo, N. Hewitt, William Andrew Publishing, p. 204) is laminated on a Carver Press to a treated (Sodium Ammonia etched) film of densified expanded PTFE (PTFE 3 mil, density of about 2.3 g/cc/THV layer 10 um thick, W. L. Gore and Associates, Inc. Elkton, Md.) at 160° C. for 30 minutes under 2.5 tons of force.

A layer of rubber based pressure sensitive adhesive (HB Fuller 1280X, HB Fuller St. Paul, Minn.) is then hot melt coated at a thickness of 1.5 mils at a temperature of 300° F.

### Example 5

A 4 inch by 6 inch 0.0005″ thick full density ePTFE tape (W.L. Gore and Associates, Inc.) was sodium ammonia etched by Porter Process Inc. located in Hatfield, Pa. The etch surface of the full density ePTFE material was then laminated in a Carver Press to a 0.029 inch thick butyl rubber layer for 2 minutes at 30 C under 2.5 tons of force.

While particular embodiments of the present invention have been illustrated and described herein, the present invention should not be limited to such illustrations and descriptions. It should be apparent that changes and modifications may be incorporated and embodied as part of the present invention within the scope of the following claims.

1. A layered article comprising
a fluoropolymer layer having a surface energy of 25 dynes/cm or less, a water contact angle of 100° or greater, and which is substantially free of pores; and
a rubber based adhesive bonded to said fluoropolymer layer,
said article having a hardness of 60 (Shore D) or less.

2. The article of claim 1, wherein said adhesive comprises butyl rubber.

3. The article of claim 1, wherein said adhesive further comprises at least one reinforcement.

4. The article of claim 3, wherein said reinforcement comprises a mesh.

5. The article of claim 1 in the form of a tape.

7. A layered article comprising:
a layer of polytetrafluoroethylene having a bulk polytetrafluoroethylene density of 2.11 g/cc or more; and
a rubber based adhesive bonded to said fluoropolymer layer,
said article having a hardness of 60 (Shore D) or less.

8. The article of claim 7, wherein said adhesive comprises butyl rubber.

9. The article of claim 7, wherein said adhesive further comprises at least one reinforcement.

10. The article of claim 7, wherein said reinforcement comprises a mesh.

11. The article of claim 7 in the form of a tape.
